(19) United States
(12) Patent Application Publication
(10) Pub. No.: US 2026/0194178 A1
(43) Pub. Date: Jul. 9, 2026

(54) QUICK-RELEASE ROTATION STRUCTURE

(71) Applicant: SHENZHEN LEQI INNOVATION CO., LTD., Shenzhen City (CN)

(72) Inventor: JIAWEI XU, Shenzhen City (CN)

(73) Assignee: SHENZHEN LEQI INNOVATION CO., LTD., Shenzhen City (CN)

(21) Appl. No.: 19/553,428

(22) Filed: Mar. 1, 2026

Related U.S. Application Data
(63) Continuation of application No. PCT/CN2024/097492, filed on Jun. 5, 2024.

(30) Foreign Application Priority Data
Sep. 1, 2023 (CN) 202322400264.3

(51) Int. Cl. F16M 11/04; F16B 2/12; G03B 17/56

(52) U.S. Cl. CPC F16M 11/041; F16B 2/12; G03B 17/561

(57) ABSTRACT

A quick-release rotation structure includes a clamping assembly having a rotation shaft, and a locking assembly having first and second rotation members, a torsion spring, clamping members, and elastic members. The first and second rotating members are each connected to at least one clamping member. The elastic members push the clamping members to clamp onto the rotation shaft. Actuating the first and second rotating members to rotate can drive the clamping members to release the rotation shaft. Locking of the rotating shaft is achieved by the elastic members applying a force to the clamping members for clamping the rotating shaft. The clamping members are driven to release the rotation shaft by rotating the first and second rotating members. The first and second rotating members are returned to their original positions by the torsion spring and elastic members, thereby realizing locking or unlocking of the clamping assembly.

### CROSS-REFERENCE TO RELATED APPLICATIONS

The present disclosure is a continuation of International Patent Application No. PCT/CN2024/097492 filed on June 5, 2024, which claims the priority of China Patent Application No. 202322400264.3, filed on September 1, 2023, the entire contents of which are incorporated herein by reference.

### TECHNICAL FIELD

The present disclosure relates to the field of photography, and in particular, to a quick-release rotation structure.

### BACKGROUND

With the rapid development of the photography industry, photographic equipment has been widely used in various work and life scenarios, people have increasingly higher functional requirements for photographic equipment, and some photographic accessories are in high demand. A quick-release rotation structure can connect to first photographic equipment such as cameras, monitors, microphones, flashlights, and fill lights through a clamping structure provided on an upper portion of the quick-release rotation structure, and can connect to second photographic equipment such as tripods and pan-tilts through an external connection component provided on a lower portion of the quick-release rotation structure, thereby connecting two different photographic equipment. To rotate and adjust the rotation angle of the first photographic equipment for better shooting effects, existing quick-release rotation structures also utilize screws that need to be repeatedly tightened or loosened to achieve clamping or release of a portion of the clamping structure, resulting in cumbersome and inconvenient operation.

### SUMMARY

The present disclosure is directed to a quick-release rotation structure, which can solve the technical problem of cumbersome operation in unlocking the rotation structure.

A quick-release rotation structure proposed by the present disclosure may generally include a clamping assembly and a locking assembly. The the clamping assembly is configured to clamp first photographic equipment, and the clamping assembly includes a rotation shaft extending into the locking assembly; the locking assembly includes a first rotation member, a second rotation member, a torsion spring, at least two clamping members, and at least two elastic members. The number of the elastic members matches the number of the clamping members. The first rotation member is connected to at least one of the clamping members, the second rotation member is connected to at least one of the clamping members, the elastic members are configured to push the clamping members to clamp onto an outer periphery of the rotation shaft, and actuating the first rotation member and the second rotation member to rotate is capable of driving the clamping members to release the rotation shaft; two force arms of the torsion spring are connected to the first rotation member and the second rotation member respectively to apply a force to the first rotation member and the second rotation member for returning the first rotation member and the second rotation member to their original positions.

In some embodiments, the quick-release rotation structure further includes a shaft base for mounting the locking assembly, wherein the shaft base is rotatably sleeved on the rotation shaft, a surface of the shaft base is recessed to form at least one elongated first sliding groove around the rotation shaft, each first sliding groove accommodates one of the clamping members and one of the elastic members, one end of the clamping member pushes the elastic member against one end of the first sliding groove, and the other end of the clamping member abuts against the rotation shaft through a groove opening at the other end of the first sliding groove. The shaft base is further recessed to form at least one elongated second sliding groove around the rotation shaft, each second sliding groove accommodates one of the clamping members and one of the elastic members, one end of the clamping member pushes the elastic member against one end of the second sliding groove, and the other end of the clamping member abuts against the rotation shaft through a groove opening at the other end of the second sliding groove; the groove opening of the first sliding groove is adjacent to or communicates with the groove opening of the second sliding groove.

In some embodiments, a first limiting portion protrudes from the first rotation member, the first limiting portion extends into the first sliding groove and abuts against a side surface of the clamping member in the first sliding groove away from the elastic member; the first limiting portion is configured to push the clamping member to release the rotation shaft upon the first rotation member being actuated. A second limiting portion protrudes from the second rotation member, and the second limiting portion extends into the second sliding groove and abuts against a side surface of the clamping member in the second sliding groove away from the elastic member; the second limiting portion is configured to push the clamping member to release the rotation shaft upon the second rotation member being actuated.

In some embodiments, the first rotation member includes a first annular portion and a first ear portion, the first annular portion centrally defines a first through hole, and an upper surface of the first annular portion is provided with multiple such first limiting portions distributed around the first through hole at intervals. The second rotation member includes a second annular portion and a second ear portion, the second annular portion centrally defines a second through hole, an inner ring portion surrounding the second through hole protrudes from an upper surface of the second annular portion, an upper part of the inner ring portion is provided with multiple such second limiting portions at uniform intervals. The torsion spring is positioned between the first annular portion and the second annular portion, and the inner ring portion is rotatably accommodated in the first through hole; when the first ear portion and the second ear portion are actuated, the first limiting portion and the second limiting portion push the clamping members to move respectively.

In some embodiments, the number of the first limiting portions is two, and the number of the second limiting portions is two; the first limiting portion is arc-shaped, or/and the second limiting portion is arc-shaped; or/and the inner ring portion is annular.

In some embodiments, the quick-release rotation structure further includes an unlocking member, wherein the unlocking member is located between the first ear portion and the second ear portion, and when the unlocking member is configured to push the first ear portion and the second ear portion to move in opposite directions upon the unlocking member moving in a first direction.

In some embodiments, side surfaces of the first ear portion and the second ear portion facing each other are first inclined surfaces, and a trapezoidal accommodating groove is formed between the two first inclined surfaces; the unlocking member includes a trapezoidal driving portion, and a free end of the driving portion is clamped between the two first inclined surfaces.

In some embodiments, the quick-release rotation structure further includes a rear shaft cover, wherein the rear shaft cover is fixed on a side of the shaft base away from the clamping assembly, the locking assembly is accommodated in an accommodating cavity formed between the rear shaft cover and the shaft base, the rear shaft cover is provided with an upper opening, allowing the first ear portion and the second ear portion to extend out of the accommodating cavity through the upper opening; one of the unlocking member and the rear shaft cover is provided with a limiting post, and the other of the unlocking member and the rear shaft cover is provided with a limiting groove.

In some embodiments, further comprising an external connection component located on a side of the rear shaft cover away from the shaft base, wherein the external connection component is configured for connecting to second photographic equipment. The quick-release rotation structure further comprises a sleeve, an open side of the sleeve is fixedly connected to the rear shaft cover, the shaft base is located inside the sleeve, one end of the rotation shaft passes through the sleeve and is fixedly connected to the clamping assembly, and one end of the unlocking member extends out of the sleeve.

In some embodiments, the clamping member is cylindrical; and/or the elastic member is a spring.

In view of the forgoing, embodiments of the present disclosure provide a quick-release rotation structure which includes a clamping assembly and a locking assembly. The clamping assembly is used for clamping first photographic equipment. The clamping assembly can clamp the first photographic equipment directly or through a photographic accessory such as a camera protection frame, a quick-release plate, or a sliding bar that is compatible with a clamping interface of the clamping assembly. The quick-release rotation structure may further include an external connection component, for connecting to second photographic equipment. The clamping assembly further includes a rotation shaft for rotatably connecting to the locking assembly. The rotation shaft can be located below the clamping assembly. After assembly, the clamping assembly can be locked to clamp the first photographic equipment. The locking assembly includes a first rotation member, a second rotation member, a torsion spring, at least two clamping members, and at least two elastic members. The elastic members are used to push the clamping members to clamp onto an outer peripheral surface of the rotation shaft to lock the rotation shaft, thereby preventing the clamping assembly from rotating relative to the locking assembly. The first rotation member is drivingly connected to at least one clamping member, and the second rotation member is drivingly connected to at least one clamping member. Actuating the first rotation member and the second rotation member to rotate can drive at least two clamping members to release the rotation shaft, allowing the clamping assembly to rotate around the locking assembly. Meanwhile, two force arms of the torsion spring generate a torque under the rotation of the first rotation member and the second rotation member, thereby adjusting a shooting angle of the electronic device clamped by the clamping assembly. Thus, unlocking the rotation shaft can be achieved through the first and second rotation members, which is simple and quick in operation. After releasing the first and second rotation members, the torsion spring can drive the first rotation member and the second rotation member to their original positions, and the elastic members and the torsion spring cooperatively return the clamping members to their original positions, making the clamping members clamp the rotation shaft again, thus achieving a simple and quick operation and stable clamping.

### BRIEF DESCRIPTION OF THE DRAWINGS

To describe the technical solutions in the embodiments of the present disclosure more clearly, the following briefly describes the accompanying drawings required for description of the embodiments. Obviously, the accompanying drawings in the following description show only some embodiments of the present disclosure, and a person of ordinary skill in the art may still derive other drawings from these drawings without creative efforts.

FIG. 1 is a schematic structural diagram of a quick-release rotation structure according to one embodiment.

FIG. 2 is a schematic structural diagram of the quick-release rotation structure of FIG. 1, viewed from another angle.

FIG. 3 is a schematic diagram showing a partial structure of the quick-release rotation structure of FIG. 1.

FIG. 4 is an exploded view of the quick-release rotation structure according to one embodiment.

FIG. 5 is a schematic diagram showing a partial structure of the quick-release rotation structure according to one embodiment.

FIG. 6 is a schematic diagram showing another partial structure of the quick-release rotation structure according to one embodiment.

FIG. 7 is a schematic structural diagram showing a rear shaft cover of the quick-release rotation structure according to one embodiment.

### List of Reference Numerals

Clamping assembly 10; Rotation shaft 11.

Locking assembly 20; Clamping member 21; Elastic member 22; First rotation member 23; First limiting portion 231; First annular portion 232; First ear portion 233; First through hole 234; Second rotation member 24; Second limiting portion 241; Second annular portion 242; Second ear portion 243; Inner ring portion 244; Second through hole 245; Unlocking member 25; Driving portion 251; Pressing portion 252; Torsion spring 26.

External connection component 30.

Shaft base 40; First sliding groove 41; Second sliding groove 42.

Rear shaft cover 50; Upper opening 51; Limiting post 52; Limiting groove 53.

Sleeve 60.

### DESCRIPTION OF THE EMBODIMENTS

The embodiments of the present disclosure are described below with reference to the accompanying drawings. Clearly, the described embodiments are only a part of the embodiments of the present disclosure, not all of them. Based on the embodiments of the present disclosure, all other embodiments obtained by those of ordinary skill in the art without creative efforts shall fall within the protection scope of the present disclosure.

It should be noted that if directional indications (such as up, down, left, right, front, back, or the like) are involved in the embodiments of the present disclosure, they are only used to explain relative positional relationships and movements of components in a specific posture (as shown in the drawings). If the specific posture changes, the directional indications change accordingly.

Additionally, if descriptions of "first", "second", or the like, are used in the embodiments of the present disclosure, they are for descriptive purposes only and cannot be understood as indicating or implying relative importance or implicitly specifying the number of technical features. Thus, features defined with "first" and "second" may explicitly or implicitly include at least one of the features. Moreover, the meaning of "and/or" throughout the text is to include three parallel options. For example, "A and/or B" includes option A, option B, or the option where both A and B are satisfied. Furthermore, technical solutions of various embodiments can be combined, but it must be based on what can be achieved by those of ordinary skill in the art. If the combination of technical solutions leads to contradictions or cannot be achieved, it should be considered that such a combination does not exist and is not within the protection scope of the present disclosure.

The present disclosure proposes a quick-release rotation structure applicable to photographic equipment. Photographic equipment is a general term for cameras, lenses and related accessories, and various devices and items related to photographic activities. Consumables like film and items such as photographic vests and bags sold by most photographic equipment dealers also belong to the category of photographic equipment, which can also be called photographic accessories. The scope of photographic equipment is broad. In addition to well-known cameras, the photographic equipment mainly includes various zoom lenses, prime lenses, flashlights, filters for various purposes, camera bags, camera tripods, studio flashlights, softboxes, various lamp stands, reflectors, reflective umbrellas, external lights, camera lights, quartz lights, lens caps, lens hoods, tripods, adapter bases, extension plates, quick-release components, brackets, monopods, camera cleaning tools, shutter releases, etc., as well as accessories for the above equipment. Traditional photographic equipment also includes printers, enlargers, safelights, glazing machines, constant temperature trays, timers, or the like, used in darkrooms. Color enlargers and printers also belong to photographic equipment. Digital cameras have integrated photography and videography, so they are more broadly called imaging equipment that covers both photography and videography.

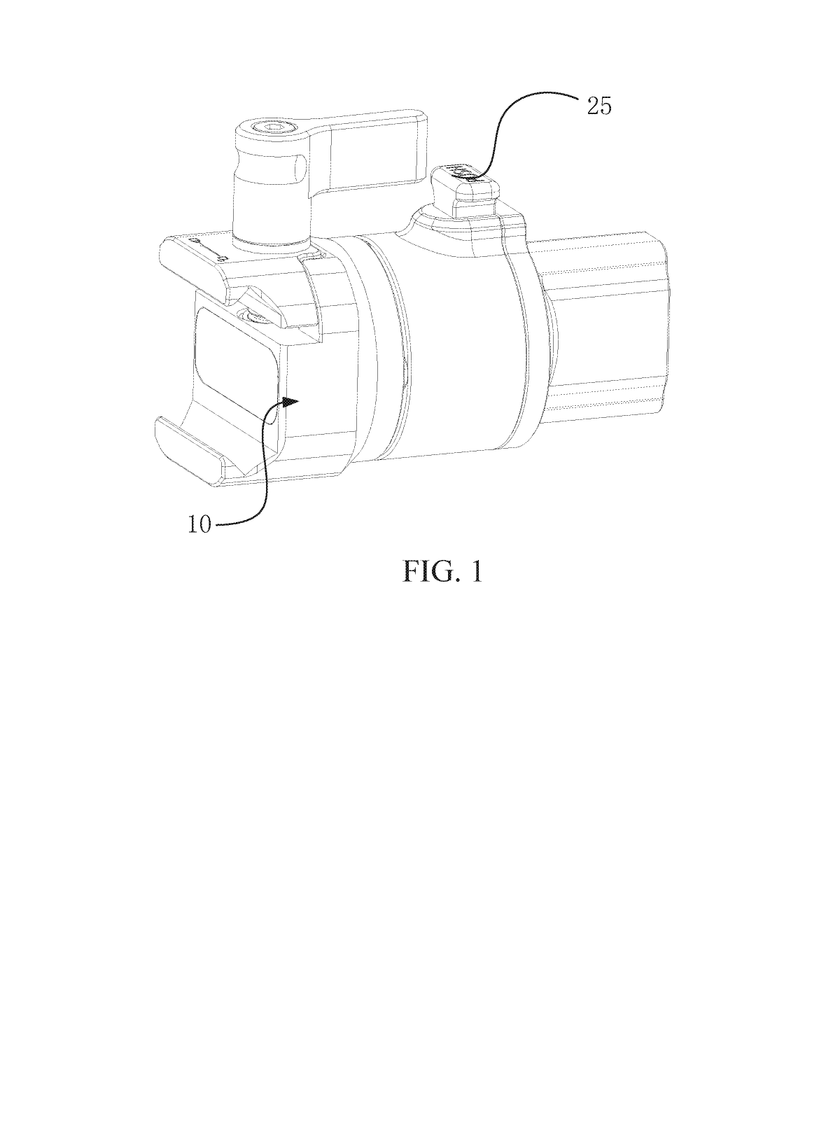

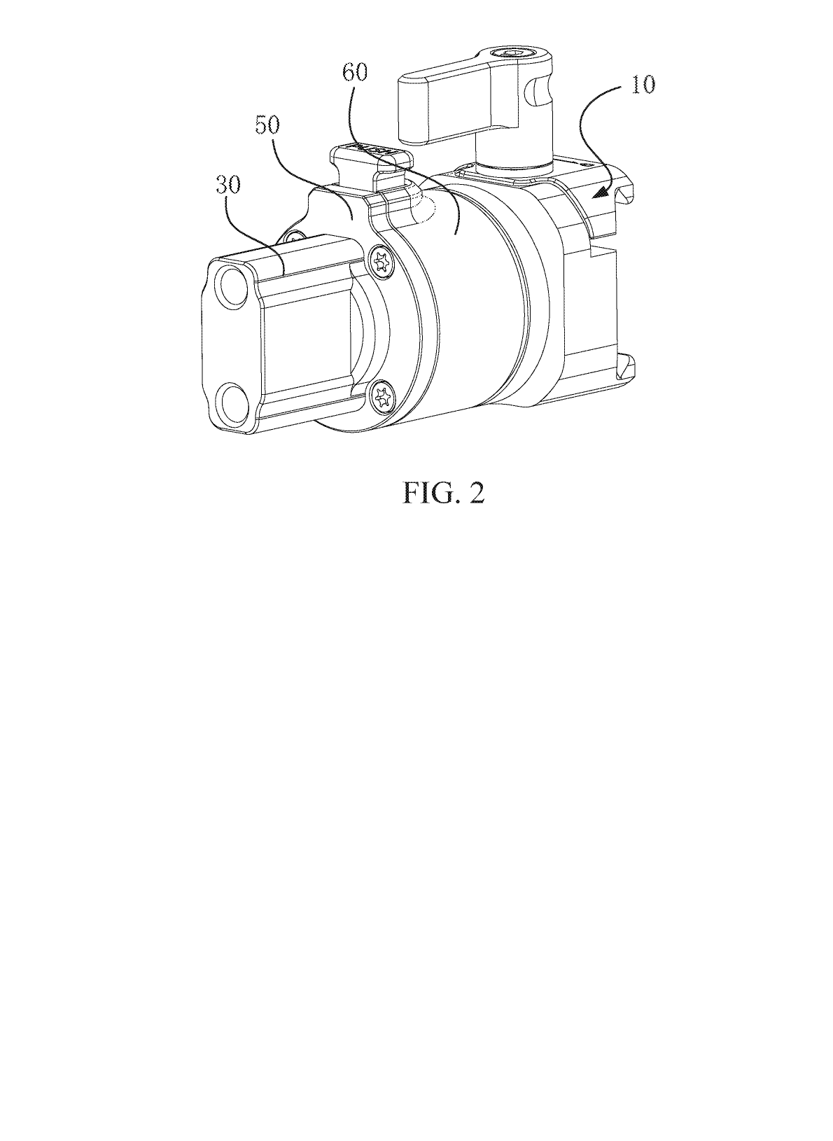

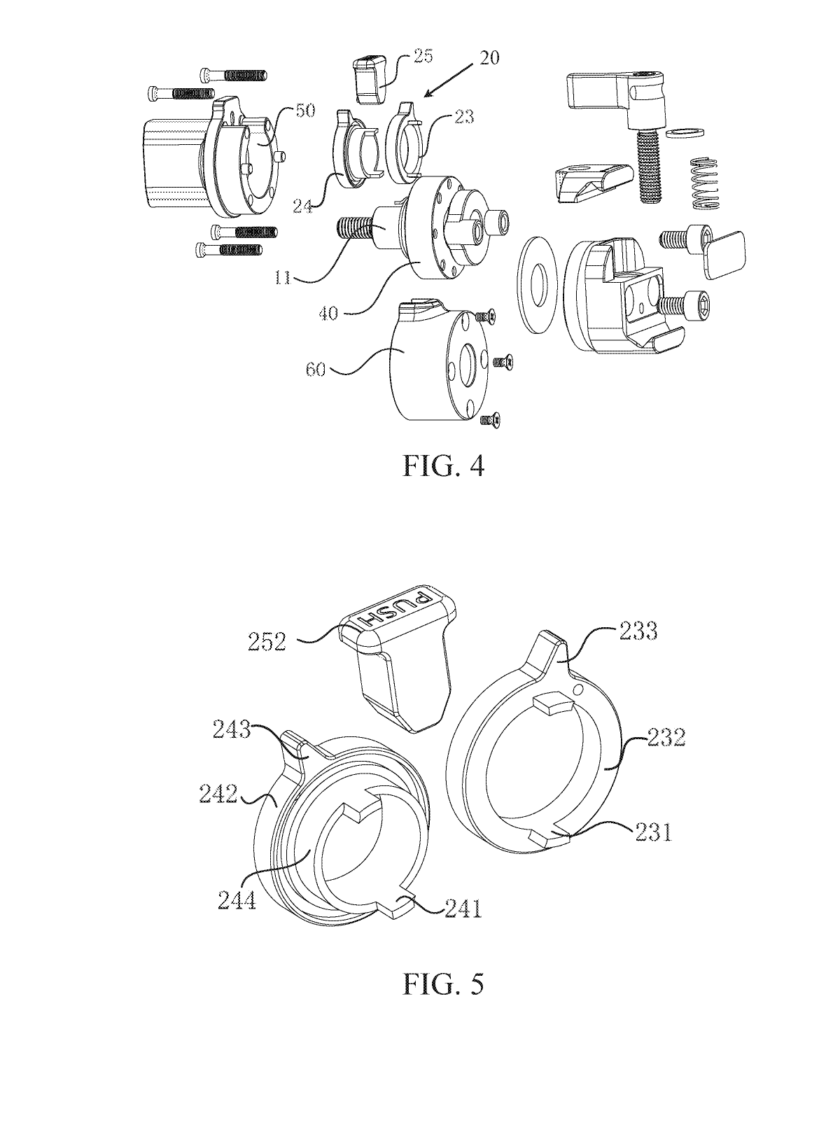

Referring to FIG. 1, FIG. 2, and FIG. 4, a quick-release rotation structure in accordance with a first embodiment of the present disclosure includes a clamping assembly 10, an external connection component 30, and a locking assembly 20. The clamping assembly 10 is configured to clamp first photographic equipment. The clamping assembly 10 can clamp the first photographic equipment directly or through a photographic accessory such as a camera protection frame, a quick-release plate, or a sliding bar that is compatible with a clamping interface of the clamping assembly 10. The external connection component 30 is configured for connection with second photographic equipment. The clamping assembly 10 further includes a rotation shaft 11 for rotatably connecting to the locking assembly 20. The rotation shaft 11 can be located below the clamping assembly 10. After assembly, the clamping assembly 10 can be locked to clamp the first photographic equipment. The locking assembly 20 includes a first rotation member 23, a second rotation member 24, a torsion spring 26, at least two clamping members 21, and at least two elastic members 22. The elastic members 22 are configured to push the clamping members 21 to clamp onto an outer peripheral surface of the rotation shaft 11 to lock the rotation shaft 11, thereby preventing the clamping assembly 10 from rotating relative to the locking assembly 20. The first rotation member 23 is drivingly connected to at least one of the clamping members 21, and the second rotation member 24 is drivingly connected to at least one of the clamping members 21. Actuating the first rotation member 23 and the second rotation member 24 to rotate can drive the at least two clamping members 21 to release the rotation shaft 11, allowing the clamping assembly 10 to rotate around the locking assembly 20. Meanwhile, two force arms of the torsion spring 26 generate a torque under the rotation of the first rotation member 23 and the second rotation member 24, thereby adjusting a shooting angle of an electronic device clamped by the clamping assembly 10. Thus, unlocking of the rotation shaft 11 can be achieved through the first rotation member 23 and the second rotation member 24, which is simple and quick in operation. After releasing the first rotation member 23 and the second rotation member 24, the torsion spring 26 drives the first rotation member 23 and the second rotation member 24 to return to their original positions, and the elastic member 22 and the torsion spring 26 cooperatively return the clamping members 21 to their original positions, making the clamping members 21 clamp the rotation shaft 11 again, achieving a simple and quick operation and stable clamping.

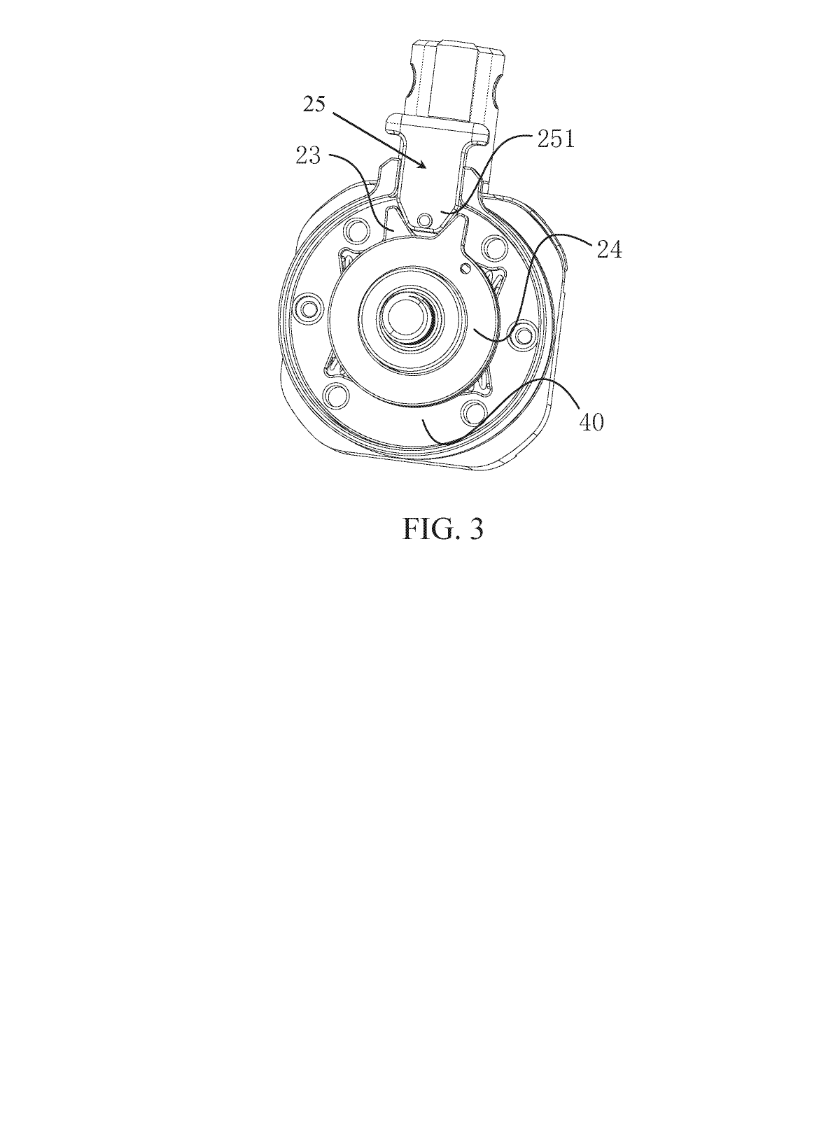

Referring to FIG. 3 through FIG. 5, in this embodiment, the first rotation member 23 and the second rotation member 24 drive two or more clamping members 21 to release the rotation shaft 11 in opposite directions. The first rotation member 23 and the second rotation member 24 can be driven manually or through other structures such as pressing structures or pushing structures.

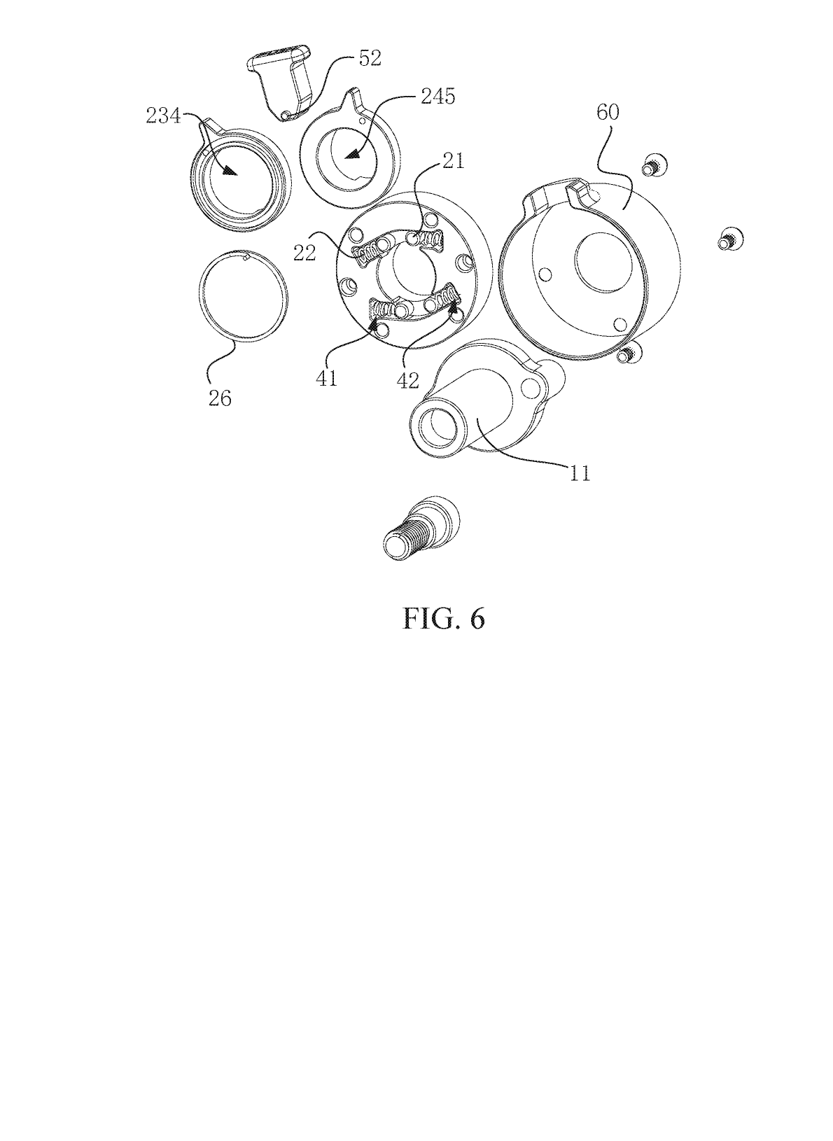

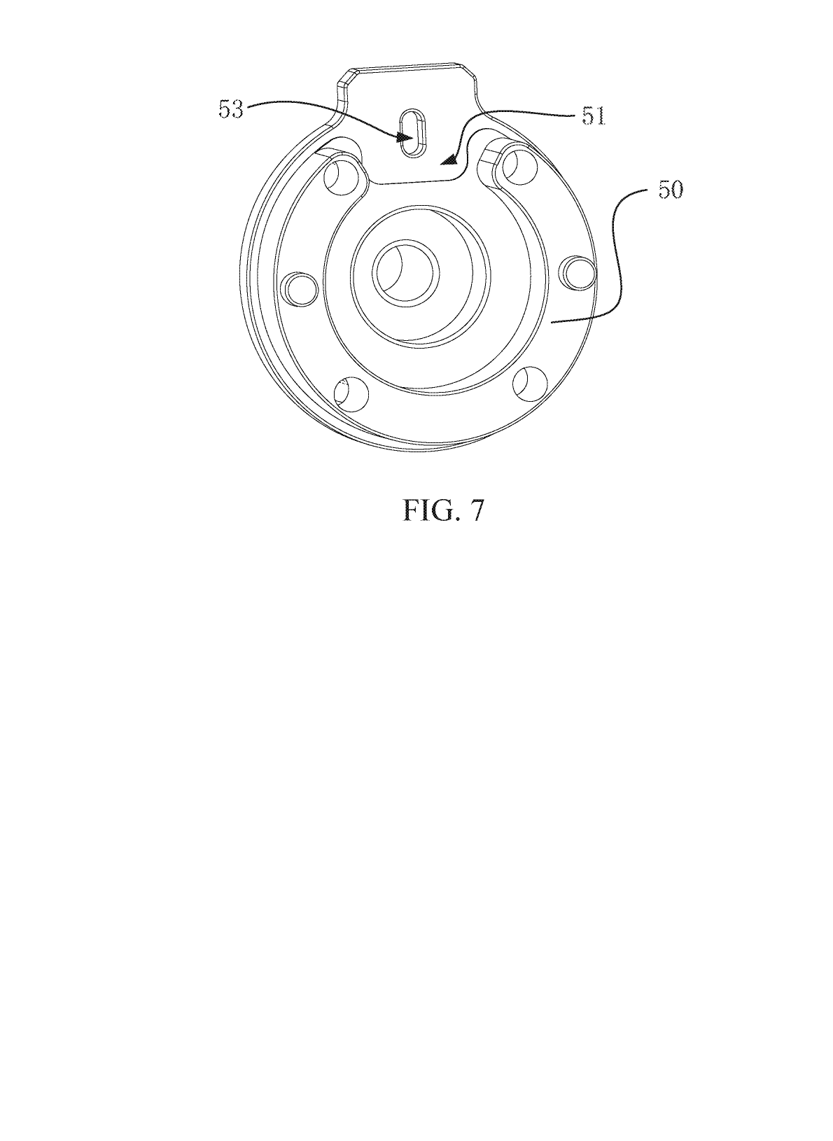

Referring to FIG. 6, specifically, to stably clamp the rotation shaft 11, the number of the clamping members 21 can be four, and correspondingly, the number of the elastic members 22 can be four. One elastic member 22 is used to push one clamping member 21. The first rotation member 23 drives two of the clamping members 21, and the second rotation member 24 drives the other two clamping members 21. The four clamping members 21 surround the outer periphery of the rotation shaft 11, with a central angle of 90° between adjacent clamping members 21. The number of the clamping members 21 can be determined according to needs, such as six or eight.

As shown in FIG. 4 and FIG. 6, the quick-release rotation structure may further include a shaft base 40 for mounting the locking assembly 20. The shaft base 40 is rotatably sleeved on the rotation shaft 11. A surface of the shaft base 40 is recessed to form at least one elongated first sliding groove 41 around the rotation shaft 11. Each first sliding groove 41 accommodates one clamping member 21 and one elastic member 22 therein. One end of the clamping member 21 pushes the elastic member 22 against one end of the first sliding groove 41, and the other end of the clamping member 21 abuts against the rotation shaft 11 through a groove opening at the other end of the first sliding groove 41.

The shaft base 40 is further recessed to form at least one elongated second sliding groove 42 around the rotation shaft 11. Each second sliding groove 42 accommodates one clamping member 21 and one elastic member 22 therein. One end of the clamping member 21 pushes the elastic member 22 against one end of the second sliding groove 42, and the other end of the clamping member 21 abuts against the rotation shaft 11 through a groove opening at the other end of the second sliding groove 42. The groove opening of the first sliding groove 41 is adjacent to or communicates with the groove opening of the second sliding groove 42, resulting in a compact and easy-to-assemble structure.

One elastic member 22 is located between one clamping member 21 and an end wall of the corresponding first sliding groove 41 or second sliding groove 42 where that elastic member 22 is located. That is, one end of the elastic member 22 is connected to the clamping member 21, and the other end is connected to the end wall of the corresponding first sliding groove 41 or second sliding groove 42. The first sliding groove 41 and the second sliding groove 42 with the communicating groove openings can form a shallow V-shape. The shaft base 40 is disk-shaped, and its thickness can be determined according to needs.

Further, as shown in FIG. 5, a first limiting portion 231 protrudes from the first rotation member 23. The first limiting portion 231 extends into the first sliding groove 41 and abuts against a side surface of the clamping member 21 in the first sliding groove away from the elastic member 22. Upon the first rotation member 23 being actuated, the first limiting portion 231 pushes the clamping member 21 to release the rotation shaft 11.

A second limiting portion 241 protrudes from the second rotation member 24. The second limiting portion 241 extends into the second sliding groove 42 and abuts against a side surface of the clamping member 21 in the second sliding groove 42 away from the elastic member 22. Upon the second rotation member 24 being actuated, the second limiting portion 241 pushes the clamping member 21 to release the rotation shaft 11.

Specifically, the first rotation member 23 includes a first annular portion 232 and a first ear portion 233. The first ear portion 233 facilitates driving the first annular portion 232 to rotate. The first annular portion 232 centrally defines a first through hole 234. The first ear portion 233 protrudes from an outer side surface of the first annular portion 232. An upper surface of the first annular portion 232 is provided with multiple first limiting portions 231 distributed around the first through hole 234 at intervals. Each first limiting portion 231 is configured to push one clamping member 21 to release the rotation shaft 11.

The second rotation member 24 includes a second annular portion 242 and a second ear portion 243. The second annular portion 242 centrally defines a second through hole 245. The second ear portion 243 protrudes from an outer side surface of the second annular portion 242. An inner ring portion 244 surrounding the second through hole 245 protrudes from an upper surface of the second annular portion 242. An upper part of the inner ring portion 244 is provided with multiple second limiting portions 241 at uniform intervals. The first rotation member 23 and the second rotation member 24 are stacked vertically, and the inner ring portion 244 is rotatably accommodated in the first through hole 234. The torsion spring 26 is positioned between the first annular portion 232 and the second annular portion 242. When the first ear portion 233 and the second ear portion 243 are actuated, the first limiting portion 231 and the second limiting portion 241 push the clamping members 21 to move respectively. One force arm of the torsion spring 26 is connected to the first annular portion 232, and the other force arm is connected to the second annular portion 242.

After assembly, one first limiting portion 231 abuts against one clamping member 21, and one second limiting portion 241 abuts against another clamping member 21. The first ear portion 233 and the second ear portion 243 can be driven to rotate manually or by other structures, causing the first ear portion 233 and the second ear portion 243 to rotate around the rotation shaft 11 in opposite directions. For example, the first ear portion 233 rotates clockwise, and the second ear portion 243 rotates counterclockwise, such that all clamping members 21 simultaneously release the rotation shaft 11, thereby allowing rotation of the clamping assembly 10.

In this embodiment, the first limiting portion 231 can be in the form of a curved or arc-shaped plate, and the second limiting portion 241 can also be in the form of a curved or arc-shaped plate. The connection between the elastic member 22 and the clamping member 21 can be a fixed connection, abutment, or a detachable connection, and is not intended to be limited to a particular connection. The elastic member 22 can be a spring, such as a compression spring or tension spring. The inner ring portion 244 is annular in shape. The multiple clamping members 21 are equidistantly distributed around the outer periphery of the rotation shaft 11.

As shown in FIG. 3 to FIG. 6, to facilitate control and adjustment of the rotation members, the quick-release rotation structure further includes an unlocking member 25. The first ear portion 233 and the second ear portion 243 can be driven to move through the unlocking member 25. Surfaces of the first ear portion 233 and the second ear portion 243 facing each other can be inclined surfaces. When the unlocking member 25 is pressed to move, opposite sides of the unlocking member 25 slide along the inclined surfaces of the first ear portion 233 and the second ear portion 243, respectively, thereby pushing the first ear portion 233 and the second ear portion 243 to move in opposite directions. In one embodiment, the first ear portion 233 and the second ear portion 243 can extend to an outside of the quick-release rotation structure, allowing direct manual actuation to move the first ear portion 233 and the second ear portion 243 in opposite directions. Upon releasing of the first ear portion 233 and the second ear portion 243, the torsion spring 26 and the elastic members 22 pushes the clamping members 21 back to their original positions, the clamping members 21 in turn pushes the first limiting portion 231 and the second limiting portion 241 back to their original positions, such that the first ear portion 233 and the second ear portion 243 are returned back to their original positions.

As shown in FIG. 3, the side surfaces of the first ear portion 233 and the second ear portion 243 facing each other are first inclined surfaces. A trapezoidal accommodating groove is formed between the two first inclined surfaces. The unlocking member 25 includes a driving portion 251 which is trapezoidal in shape, and a free end of the driving portion 251 is clamped between the two first inclined surfaces.

The driving portion 251 is provided at one end of the unlocking member 25, and the other end of the unlocking member 25 is provided with a pressing portion 252. The pressing portion 252 extends to an outside of the shaft base 40 for user pressing. The driving portion 251 is located between the first ear portion 233 and the second ear portion 243. The inclined surfaces of the first ear portion 233 and the second ear portion 243 facing each other form an inverted triangular or trapezoidal space. A periphery of the driving portion 251 is correspondingly shaped as an inverted triangle or trapezoid. Pressing the pressing portion 252 causes the driving portion 251 to slide along the inclined surfaces of the first ear portion 233 and the second ear portion 243, increasing the angle between the first ear portion 233 and the second ear portion 243. This causes the first limiting portion 231 and the second limiting portion 241 to slide simultaneously, pushing the respective clamping members 21 to make all the clamping members 21 release the rotation shaft 11. Releasing the pressing portion 252 allows the torsion spring 26 to move the first rotation member 23 and the second rotation member 24 back to their reset positions, while the elastic members 22 push the clamping members 21 back to their positions. The first ear portion 233 can be a flat triangle in shape, and the second ear portion 243 can also be a flat triangle.

The quick-release rotation structure may further include a rear shaft cover 50. The rear shaft cover 50 is fixed on a side of the shaft base 40 away from the clamping assembly 10. Both the first rotation member 23 and the second rotation member 24 are accommodated in an accommodating cavity formed between the rear shaft cover 50 and the shaft base 40. The rear shaft cover 50 is provided with an upper opening 51, allowing the first ear portion 233 and the second ear portion 243 to extend out of the accommodating cavity. One of the unlocking member 25 and the rear shaft cover 50 is provided with a limiting post 52, and the other is provided with a limiting groove 53 for receiving the limiting post 52. For example, the rear shaft cover 50 includes a limiting groove 53 extending along a sliding direction of the unlocking member 25, and the surface of the unlocking member 25 is provided with a limiting post 52. The provision of the limiting post 52 and the limiting groove 53 restricts a sliding range of the unlocking member 25, thus improving stability during sliding.

As shown in FIG. 5 and FIG. 7, the quick-release rotation structure may further include an external connection component 30 on a side of the rear shaft cover 50 away from the shaft base 40. The external connection component 30 is configured for connection with second photographic equipment.

The quick-release rotation structure further includes a sleeve 60. An open side of the sleeve 60 is fixedly connected to the rear shaft cover 50, and the shaft base 40 and the locking assembly 20 are located inside the sleeve 60. One end of the rotation shaft 11 passes through the sleeve 60 and is fixedly connected to the clamping assembly 10. The pressing portion 252 of the unlocking member 25 extends out of the sleeve 60.

In summary, after the quick-release rotation structure is assembled, all clamping members 21 clamp onto the outer periphery of the rotation shaft 11, with the driving portion 251 located in the trapezoidal space formed by the first inclined surfaces of the first ear portion 233 and the second ear portion 243. To unlock the rotation shaft 11, the pressing portion 252 is pressed downwards, such that the limiting post 52 slides along the limiting groove 53, and the opposite sides of the driving portion 251 slide along the first inclined surfaces of the first ear portion 233 and the second ear portion 243, causing the first ear portion 233 and the second ear portion 243 to rotate in opposite directions. This causes the torsion spring 26 to generate a torque. The rotation of the first ear portion 233 drives the first annular portion 232 to rotate, causing a first limiting portion 231 to push one clamping member 21 away from the central axis of the rotation shaft 11, thereby releasing the rotation shaft 11; the rotation of the second ear portion 243 drives the second annular portion 242 to rotate, causing a second limiting portion 241 to push another clamping member 21 away from the central axis of the rotation shaft 11, thereby releasing the rotation shaft 11. All elastic members 22 are compressed, causing all clamping members 21 to release the rotation shaft 11. The user can then rotate the rotation shaft 11 to rotate the clamping assembly 10, so as to adjust the angle of the first photographic equipment, such as adjusting the shooting angle of an electronic device such as a camera.

After adjustment, the pressing portion 252 is released, which allows the torsion spring 26 to move the first rotation member 23 and the second rotation member 24 back to their original positions. Simultaneously, the first inclined surfaces of the first ear portion 233 and the second ear portion 243 push the driving portion 251 upwards to its original position, and the elastic members 22 push the clamping members 21 back to their original positions, such that the first ear portion 233 and the second ear portion 243 rotate towards each other to their original positions. When the first ear portion 233 rotates to drive the first annular portion 232 to rotate, the elastic members 22 push the clamping members 21 back to their original positions, the clamping members 21 in turn pushing the first limiting portion 231 to its original position. When the second ear portion 243 rotates to drive the second annular portion 242 to rotate, the elastic members 22 push the clamping members 21 to their original positions, the elastic members 22 in turn pushing the second limiting portion 241 to its original position. As such, all clamping members 21 return to their original positions, i.e., all clamping members 21 pressing against the outer peripheral surface of the rotation shaft 11 to thereby lock the rotation shaft 11.

In some embodiments, there can be one or more clamping members 21, as long as the clamping member 21 can press against the rotation shaft 11. For example, there can be two elastic members 22 and two clamping members 21, the two clamping members 21 can clamp on opposite sides of the rotation shaft 11, a hypothetical line connecting the two clamping members 21 can pass through the centerline of the rotation shaft 11, and the clamping members 21 correspond to the first and second limiting portions. In another example, there are three elastic members 22 and three clamping members 21, the three clamping members 21 can clamp around the outer surface of the rotation shaft 11, with a central angle of 120° between adjacent clamping members 21, and the three clamping members 21 correspond to three evenly spaced limiting portions. Therefore, the number of the elastic members 22 and clamping members 21 is not limited, as long as they can clamp the rotation shaft 11.

In some embodiments, the clamping assembly 10 can have various configurations. In one embodiment, the clamping assembly 10 includes a clamping base with a clamping groove. A groove wall on one side of the clamping groove can be moved closer to or farther from another groove wall on the other side via a screw to achieve locking or unlocking of an item to be clamped by the clamping assembly 10. One end of the rotation shaft 11 may be fixedly connected to a side of the clamping base opposite the clamping groove using a fastener such as a screw. The other end of the rotation shaft 11 can be rotatably connected to the rear shaft cover 50 via a screw.

In one embodiment, the clamping assembly 10 includes a threaded disc, two clamping jaws, and a fixed base. An upper surface of the threaded disc has a groove formed along a spiral line. A lower end of each clamping jaw has several fixed teeth which are spaced apart to form a thread. The fixed teeth of the clamping claw are nested within the spiral groove. A clamping space is formed between the two clamping jaws for clamping the first photographic equipment such as a quick-release plate. The fixed base is rotatably connected to the threaded disc. The fixed base has two radial limiting grooves, each limiting one clamping jaw. A bottom surface of the fixed base is provided with a rotation shaft 11, which passes through a central hole of the threaded disc. A lower surface of the threaded disc is recessed to form an accommodating space, which allows the threaded disc to cover around an upper periphery of the shaft base 40, resulting in a compact and tightly connected structure. The locking control of the clamping assembly 10 and the locking assembly 20 can be performed separately without interfering with each other.

Rotation of threaded disc causes relative motion between the spiral groove of the threaded disc and the fixed teeth of the clamping jaws, in which the fixed teeth of the clamping jaws slide within the spiral groove of the threaded disc, and their motion pair resembles the form of a threaded connection. The spiral groove formed by the spiral line and the fixed teeth on the clamping jaw constitute a structure similar to a threaded pair.

When the threaded disc is rotated forward, the relative motion between the spiral groove on the disc and the fixed teeth on the clamping jaws, constrained by the limiting grooves in the fixed base, causes the clamping jaws to move closer together radially, thereby achieving clamping of photographic accessories (e.g. quick-release plate) of different sizes. After clamping, no further locking via the locking assembly 20 is needed, making the structure compact and simple with convenient operation. To unlock, the threaded disc is rotated reversely, and the spiral groove on the threaded disc and the fixed teeth of the clamping jaws move relatively such that, under the constraint of the limiting grooves in the fixed base, the clamping jaws move radially away from each other and release the photographic accessory. Using two clamping jaws moving radially simultaneously allows for clamping and fixing photographic accessories such as quick-release plates and sliding bars of different sizes. Forward and reverse rotations are rotations in opposite directions. For example, forward rotation is clockwise rotation, and reverse rotation is counterclockwise rotation, which conform to user habits and can improve the user experience. The clamping jaws can be located on one side of the fixed base, while the other side of the fixed base can connect to another photographic accessory or equipment, thereby enabling portability, easy disassembly and assembly, and wide applicability of the threaded-disc-based quick release structure.

In some implementations, the external connection component 30 includes an external connection base located below the shaft base 40. Opposite two sides of the external connection base have inclined edges. Alternatively, opposite two sides of the external connection base have inclined edges, another opposite two sides of the external connection base also have inclined edges, and these inclined edges are connected by curved surfaces, allowing for mounting in any orientation, thus providing great adaptability. A bottom surface of the external connection base has a cross groove for engaging with other quick-release structures.

An electronic device such as a camera can be locked onto the upper surface of a quick-release plate via a crew, the quick-release plate is then slid into the dovetail clamping space. When threaded disc is moved forward, the spiral grooves on the threaded disc and the fixed teeth of the clamping jaws move relatively, such that, under the constraint of the limiting grooves of the fixed base, the clamping jaws move radially closer, reducing the clamping space until the inclined edges of the two clamping jaws engage the opposite sides of the photographic accessory (i.e., the quick-release plate). The external connection base of the external connection component 30 can be clamped to other quick-release structures, thereby connecting the electronic device. To unlock the clamping assembly 10, the threaded disc is rotated reversely, and the spiral groove on the threaded disc and the fixed teeth of the clamping jaws move relatively, such that, under the constraint of the limiting grooves of the fixed base, the clamping jaws move radially away from each other and release the opposite sides of the photographic accessory (i.e. the quick-release plate), allowing the quick-release plate to slide out from between the inclined edges of the two clamping jaws, thus releasing and unlocking the photographic accessory.

In some embodiments, the external connection component 30 can also be a clamping structure, a threaded structure, a snap-fit structure, or the like, which are not enumerated here. The second photographic equipment can include a side handle, a top handle, or the like. As shown in FIG. 2, for example, the threaded structure includes a mounting base with a threaded hole.

The above descriptions are only optional embodiments of the present disclosure and do not limit the patent scope of the present disclosure. Any equivalent structural transformations made under the inventive concept of the present disclosure using the embodiments and drawings of the present disclosure, or direct/indirect application in other related technical fields, are included within the patent protection scope of the present disclosure.

What is claimed is:

1. A quick-release rotation structure, comprising a clamping assembly and a locking assembly, wherein the clamping assembly is configured to clamp first photographic equipment, and the clamping assembly includes a rotation shaft extending into the locking assembly; the locking assembly includes a first rotation member, a second rotation member, a torsion spring, at least two clamping members, and at least two elastic members, wherein the number of the elastic members matches the number of the clamping members;
wherein the first rotation member is connected to at least one of the clamping members, the second rotation member is connected to at least one of the clamping members, the elastic members are configured to push the clamping members to clamp onto an outer periphery of the rotation shaft, and actuating the first rotation member and the second rotation member to rotate is capable of driving the clamping members to release the rotation shaft; two force arms of the torsion spring are connected to the first rotation member and the second rotation member respectively to apply a force to the first rotation member and the second rotation member for returning the first rotation member and the second rotation member to their original positions.

2. The quick-release rotation structure according to claim 1, further comprising a shaft base for mounting the locking assembly, wherein the shaft base is rotatably sleeved on the rotation shaft, a surface of the shaft base is recessed to form at least one elongated first sliding groove around the rotation shaft, each first sliding groove accommodates one of the clamping members and one of the elastic members, one end of the clamping member pushes the elastic member against one end of the first sliding groove, and the other end of the clamping member abuts against the rotation shaft through a groove opening at the other end of the first sliding groove;
wherein the shaft base is further recessed to form at least one elongated second sliding groove around the rotation shaft, each second sliding groove accommodates one of the clamping members and one of the elastic members, one end of the clamping member pushes the elastic member against one end of the second sliding groove, and the other end of the clamping member abuts against the rotation shaft through a groove opening at the other end of the second sliding groove; the groove opening of the first sliding groove is adjacent to or communicates with the groove opening of the second sliding groove.

3. The quick-release rotation structure according to claim 2, wherein a first limiting portion protrudes from the first rotation member, the first limiting portion extends into the first sliding groove and abuts against a side surface of the clamping member in the first sliding groove away from the elastic member; the first limiting portion is configured to push the clamping member to release the rotation shaft upon the first rotation member being actuated;
wherein a second limiting portion protrudes from the second rotation member, the second limiting portion extends into the second sliding groove and abuts against a side surface of the clamping member in the second sliding groove away from the elastic member; the second limiting portion is configured to push the clamping member to release the rotation shaft upon the second rotation member being actuated.

4. The quick-release rotation structure according to claim 3, wherein the first rotation member includes a first annular portion and a first ear portion, the first annular portion centrally defines a first through hole, and an upper surface of the first annular portion is provided with multiple such first limiting portions distributed around the first through hole at intervals;
the second rotation member includes a second annular portion and a second ear portion, the second annular portion centrally defines a second through hole, an inner ring portion surrounding the second through hole protrudes from an upper surface of the second annular portion, an upper part of the inner ring portion is provided with multiple such second limiting portions at uniform intervals; the torsion spring is positioned between the first annular portion and the second annular portion, and the inner ring portion is rotatably accommodated in the first through hole; when the first ear portion and the second ear portion are actuated, the first limiting portion and the second limiting portion push the clamping members to move respectively.

5. The quick-release rotation structure according to claim 4, wherein the number of the first limiting portions is two, and the number of the second limiting portions is two; the first limiting portion is arc-shaped, or/and the second limiting portion is arc-shaped; or/and the inner ring portion is annular.

6. The quick-release rotation structure according to claim 4, further comprising an unlocking member, wherein the unlocking member is located between the first ear portion and the second ear portion, and when the unlocking member is configured to push the first ear portion and the second ear portion to move in opposite directions upon the unlocking member moving in a first direction.

7. The quick-release rotation structure according to claim 6, wherein side surfaces of the first ear portion and the second ear portion facing each other are first inclined surfaces, and a trapezoidal accommodating groove is formed between the two first inclined surfaces; the unlocking member includes a trapezoidal driving portion, and a free end of the driving portion is clamped between the two first inclined surfaces.

8. The quick-release rotation structure according to claim 6, further comprising a rear shaft cover, wherein the rear shaft cover is fixed on a side of the shaft base away from the clamping assembly, the locking assembly is accommodated in an accommodating cavity formed between the rear shaft cover and the shaft base, the rear shaft cover is provided with an upper opening, allowing the first ear portion and the second ear portion to extend out of the accommodating cavity through the upper opening; one of the unlocking member and the rear shaft cover is provided with a limiting post, and the other of the unlocking member and the rear shaft cover is provided with a limiting groove.

9. The quick-release rotation structure according to claim 8, further comprising an external connection component located on a side of the rear shaft cover away from the shaft base, wherein the external connection component is configured for connecting to second photographic equipment;
wherein the quick-release rotation structure further comprises a sleeve, an open side of the sleeve is fixedly connected to the rear shaft cover, the shaft base is located inside the sleeve, one end of the rotation shaft passes through the sleeve and is fixedly connected to the clamping assembly, and one end of the unlocking member extends out of the sleeve.

10. The quick-release rotation structure according to claim 1, wherein the clamping member is cylindrical; and/or the elastic member is a spring.
